(19) United States
(12) Patent Application Publication
(10) Pub. No.: US 2025/0276624 A1
(43) Pub. Date: Sep. 4, 2025

(54) BLOWER PROTECTION STRUCTURE OF A SEATBACK, AND VEHICLE SEAT

(71) Applicants: NHK SPRING CO., LTD., Yokohama-shi (JP); SUBARU CORPORATION, Tokyo (JP)

(72) Inventors: Kenzo YASUDA, Yokohama-shi (JP); Kazuhiro TOYOSHIMA, Yokohama-shi (JP); Yosuke ISHIYAMA, Tokyo (JP); Masato FUKUSHIMA, Tokyo (JP)

(21) Appl. No.: 19/063,156

(22) Filed: Feb. 25, 2025

(30) Foreign Application Priority Data
Mar. 4, 2024 (JP) 2024-032466

(51) Int. Cl. B60N 2/56

(52) U.S. Cl. CPC B60N 2/5621

(57) ABSTRACT

A blower protection structure of a seatback has a pair of left and right lumbar wires spanning between an upper portion and a lower portion of a seatback frame of a vehicle seat, a mounting bracket mounted directly or indirectly to the left and right lumbar wires, a blower disposed at a seatback rear side with respect to the mounting bracket, and an urging portion urging the blower toward the mounting bracket side.

### CROSS-REFERENCE TO RELATED APPLICATION

This application is based on and claims priority under 35 USC 119 from Japanese Patent Application No. 2024-032466, filed on Mar. 4, 2024, the disclosure of which is incorporated by reference herein.

### BACKGROUND

### Technical Field

The present disclosure relates to a vehicle seat, and in particular, to a blower protection structure of a seatback.

### Related Art

A vehicle seat that is used as a front seat of a vehicle is disclosed in Japanese Patent Application Laid-Open (JP-A) No. 2018-144605. In this vehicle seat, a pair of left and right wires (lumbar wires) span between the upper portion and the lower portion of a seatback frame. A plate (a mounting bracket) is mounted to the left and right lumbar wires. A blower is mounted to the mounting bracket. The blower is a fan for a seat ventilation system that promotes ventilating of the surface of the seatback by generating an airflow at the surface of the seatback.

### SUMMARY

In the above-described prior art technique, at times such as when an occupant transfers to a back seat in a state in which the seatback of the front seat has been reclined, if the occupant kneels on the seatback and the weight of the occupant is applied directly on the blower, there are cases in which the mounted-together portions of the blower and the mounting bracket break. In this case, the blower draws secondary air in from the gap between the blower and the mounting bracket, the amount of air that is drawn-in from the occupant side decreases, the cooling sensation for the occupant deteriorates, and noise increases.

An object of the present disclosure is to provide a blower protection structure of a seatback and a vehicle seat that can prevent or suppress drawing-in of secondary air.

A blower protection structure of a seatback of a first aspect of the present disclosure has a pair of left and right lumbar wires spanning between an upper portion and a lower portion of a seatback frame of a vehicle seat, a mounting bracket mounted directly or indirectly to the left and right lumbar wires, a blower disposed at a seatback rear side with respect to the mounting bracket, and an urging portion urging the blower toward a mounting bracket side.

In the blower protection structure of a seatback of the first aspect, the pair of left and right lumbar wires span between the upper portion and the lower portion of the seatback frame of a vehicle seat. The mounting bracket is mounted directly or indirectly to the left and right lumbar wires. The blower is disposed at a seatback rear side with respect to the mounting bracket. The blower is urged toward the mounting bracket side by the urging portion. Due thereto, a gap forming between the blower and the mounting bracket can be prevented or suppressed, and therefore, the blower drawing secondary air in from the aforementioned gap can be prevented or suppressed.

In a blower protection structure of a seatback of a second aspect, in the first aspect, the blower is mounted to a seatback rear side surface of the mounting bracket.

In the blower protection structure of a seatback of the second aspect, for example, even in a case in which an occupant kneels on the seatback that has been reclined and the mounted-together portions of the blower and the mounting bracket are broken, the blower can be held at the mounting bracket by the urging portion. Accordingly, a failsafe function in a case in which the aforementioned mounted-together portions are broken can be ensured.

In a blower protection structure of a seatback of a third aspect, in the first aspect or the second aspect, the urging portion has an elongated extending/contracting portion that is configured to extend and contract, and the urging portion is wound on the mounting bracket and the blower.

In the blower protection structure of a seatback of the third aspect, the urging portion, which has the elongated extending/contracting portion that is configured to extend and contract, is wound on the mounting bracket and the blower. Therefore, it is easy to mount the urging portion to the mounting bracket and the blower.

In a blower protection structure of a seatback of a fourth aspect, in third aspect, the urging portion has a sheet-shaped portion that is formed in a shape of a sheet whose thickness direction is a front-rear direction of the seatback, that is disposed at the seatback rear side with respect to the blower, and to which the elongated extending/contracting portion is fixed.

In accordance with the blower protection structure of a seatback of the fourth aspect, the sheet-shaped portion, which is formed in the shape of a sheet whose thickness direction is the front-rear direction of the seatback, is disposed at the seatback rear side with respect to the blower. The elongated extending/contracting portion, which is elongated and fixed to the sheet-shaped portion, is wound on the mounting bracket and the blower. The blower can be protected from the seatback rear side by this sheet-shaped portion.

In a blower protection structure of a seatback of a fifth aspect, in the fourth aspect, the elongated extending/contracting portion is wound on the sheet-shaped portion, and the sheet-shaped portion has a positioning portion that positions the elongated extending/contracting portion at the sheet-shaped portion by engaging with a length direction intermediate portion of the elongated extending/contracting portion.

In the blower protection structure of a seatback of the fifth aspect, the elongated elongated extending/contracting portion is wound on the sheet-shaped portion that is disposed at the seatback rear side with respect to the blower, and the positioning portion provided at the sheet-shaped portion is engaged with a length direction intermediate portion of the elongated extending/contracting portion. Due thereto, the elongated extending/contracting portion is positioned with respect to the sheet-shaped portion, and therefore, the intake and exhaust ports of the blower can be prevented from becoming blocked by the elongated extending/contracting portion whose position has become offset for example.

In a blower protection structure of a seatback of a sixth aspect, in the fourth aspect or the fifth aspect, a positioning hole into which a portion of the blower is fit is formed in the sheet-shaped portion.

In the blower protection structure of a seatback of the sixth aspect, a portion of the blower is fit into the positioning hole of the sheet-shaped portion that is disposed at the seatback rear side with respect to the blower. Therefore, positional offset of the sheet-shaped portion with respect to the blower can be prevented. As a result, the intake and exhaust ports of the blower can be prevented from becoming blocked by the sheet-shaped portion whose position has become offset for example.

In a blower protection structure of a seatback of a seventh aspect, in the fourth aspect, the sheet-shaped portion is structured by a fabric-like material.

In the blower protection structure of a seatback of the seventh aspect, the sheet-shaped portion, which is disposed at the seatback rear side with respect to the blower, is structured by a fabric-like material. Therefore, the blower can effectively be protected from the seatback rear side by the sheet-shaped portion.

A vehicle seat of an eighth aspect has a seat cushion on which an occupant sits, and a seatback supporting a back of the occupant, wherein the seatback has the blower protection structure of a seatback of any one of the first aspect through the seventh aspect.

In the vehicle seat of the eighth aspect, the back of the occupant seated on the seat cushion is supported by the seatback. Because this seatback has the blower protection structure of a seatback of any one of the first aspect through the seventh aspect, the above-described effects are achieved.

As described above, in accordance with the blower protection structure of a seatback and the vehicle seat relating to the present disclosure, the drawing-in of secondary air can be prevented or suppressed.

### BRIEF DESCRIPTION OF THE DRAWINGS

Exemplary embodiments of the present invention will be described in detail based on the following figures, wherein:

FIG. 1 is a side view illustrating a vehicle seat relating to a first embodiment;

FIG. 2 is a perspective view illustrating a portion of a seatback of the vehicle seat;

FIG. 3 is a first perspective view illustrating a mounting bracket, a blower and an urging portion;

FIG. 4 is a second perspective view illustrating the mounting bracket, the blower and the urging portion;

FIG. 5 is a perspective view illustrating the mounting bracket;

FIG. 6 is a perspective view illustrating the blower;

FIG. 7 is a perspective view illustrating the urging portion;

FIG. 8 is a development drawing illustrating the urging portion;

FIG. 9 is a side view, corresponding to FIG. 1, for explaining load applied to the seatback that has been reclined;

FIG. 10 is a side view, corresponding to FIG. 1, for explaining load applied to the back surface of the seatback;

FIG. 11 is a first perspective view illustrating the blower and an urging portion of a vehicle seat relating to a second embodiment; and

FIG. 12 is a second perspective view illustrating the blower and the urging portion of the vehicle seat relating to the second embodiment.

### DETAILED DESCRIPTION

### First Embodiment

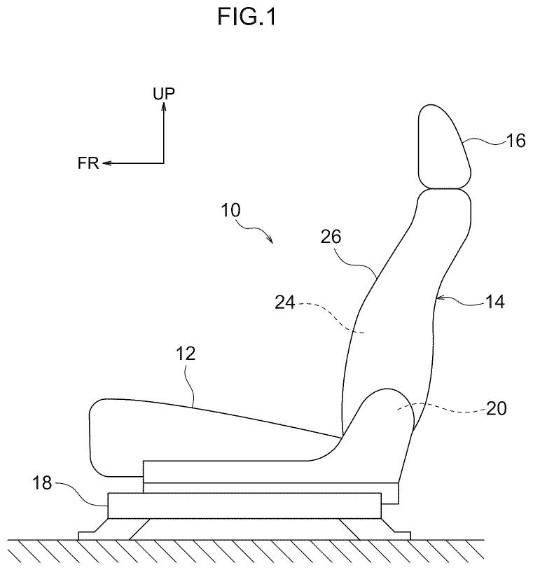

A vehicle seat 10 relating to a first embodiment of the present disclosure is described hereinafter with reference to FIG. 1 through FIG. 10. Note that, in the respective drawings, there are cases in which some of the reference numerals are omitted in order to make the drawings easier to understand. Further, arrows FR, LH, RH and UP that are shown appropriately in the respective drawings indicate the forward, leftward, rightward and upward of the vehicle seat 10, respectively. Hereinafter, when explanation is given by using merely front-rear, left-right and vertical directions, they refer to the directions with respect to the vehicle seat 10.

As illustrated in FIG. 1, the vehicle seat 10 relating to the present embodiment is, as an example, a front seat of a vehicle, and has a seat cushion 12 on which an occupant sits, a seatback 14 supporting the back of the occupant, and a headrest 16 supporting the head of the occupant. The seat cushion 12 is connected to the floor of the vehicle via a known sliding mechanism 18. The lower end portion of the seatback 14 is connected to the rear end portion of the seat cushion 12 via a known reclining mechanism 20. The headrest 16 is connected to the upper end portion of the seatback 14 such that the vertical position thereof is adjustable.

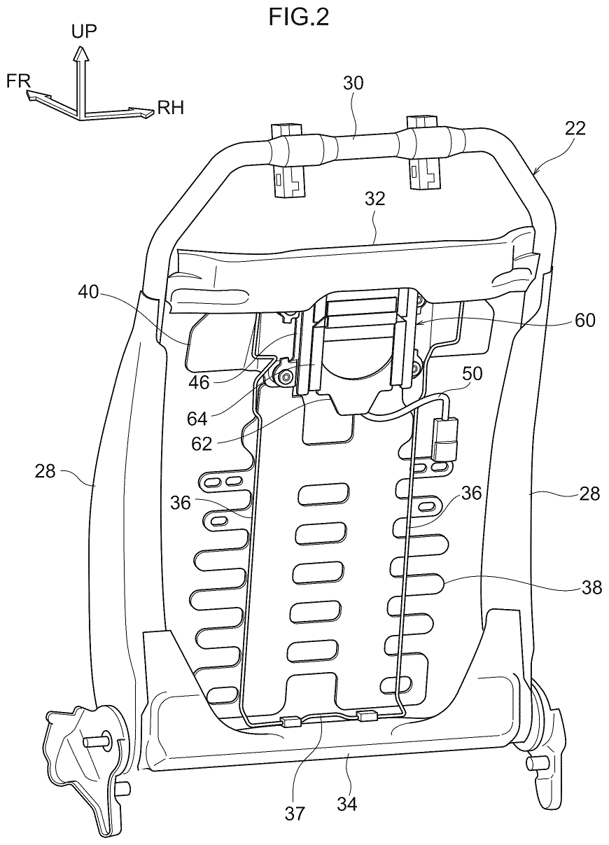

The seatback 14 has a seatback frame 22 (see FIG. 2) that is a frame member, a seatback pad 24 that is a cushion material, and a trim cover 26 that is a cover material. As illustrated in FIG. 2, the seatback frame 22 has a pair of left and right side frames 28, an upper frame 30 connecting the upper end portions of the left and right side frames 28 in the left-right direction, an upper bracket 32 mounted to the upper frame 30, and a lower frame 34 connecting the lower end portions of the left and right side frames 28 in the left-right direction.

The left and right side frames 28, the upper bracket 32 and the lower frame 34 are, for example, structured by plate members made of metal that have been press molded. The upper frame 30 is, for example, structured by a pipe member made of metal that has been bent. The upper frame 30 is formed in a substantially upside-down U shape as seen in the front-rear direction, and the upper bracket 32 spans between the left and right both end portions at the lower portion of the upper frame 30.

The seatback pad 24 is, for example, structured by a foamed body such as urethane foam, and is covered on the seatback frame 22 from the upper side thereof. The trim cover 26 is, for example, formed in the shape of a bag due to plural cover pieces formed from a fabric material, leather or synthetic leather being sewn together, and is covered on the seatback pad 24 from the upper side thereof.

A pair of left and right lumbar wires 36 span between the upper bracket 32 provided at the upper portion of the seatback frame 22 and the lower frame 34 provided at the lower end portion of the seatback 14. The left and right lumbar wires 36 extend in the vertical direction, and are disposed with an interval therebetween in the left-right direction. The lower end portions of the left and right lumbar wires 36 are connected in the left-right direction by a connecting wire 37, and the connecting wire 37 is fixed to the lower frame 34. The left and right lumbar wires 36 and the connecting wire 37 are, for example, structured integrally by a wire material made of metal.

A lumbar support plate 38 is mounted to the left and right lumbar wires 36 via an unillustrated lumbar support driving mechanism. The lumbar support plate 38 is, for example, structured by an injection-molded resin, and is formed substantially in the shape of a plate whose length direction is the vertical direction and whose thickness direction is the front-rear direction. This lumbar support plate 38 is disposed at the front sides of the left and right lumbar wires 36, and contacts the back surface of the seatback pad 24. The lumbar support driving mechanism displaces the lumbar support plate 38 in the front-rear direction by the driving force of a motor. Due thereto, the strength of supporting the lumbar region of the occupant is adjusted.

A mounting bracket 40 is disposed within the seatback 14, above the lumbar support plate 38. The mounting bracket 40 is, for example, structured in the shape of a plate from an injection-molded resin, and is formed substantially in the shape of a plate whose length direction is the left-right direction and whose thickness direction is the front-rear direction. The mounting bracket 40 is disposed at the front sides of the left and right lumbar wires 36, and is indirectly mounted to the left and right lumbar wires 36 via other wires that are not illustrated and the above-described lumbar support mechanism. Note that the mounting bracket 40 may be structured so as to be mounted directly to the left and right lumbar wires 36.

As illustrated in FIG. 2 through FIG. 4, a blower 46 is mounted to the left-right direction central portion of the mounting bracket 40. The blower 46 is disposed at the rear side of the mounting bracket 40. The blower 46 is a centrifugal blower for example, and has an unillustrated turbo fan whose axial direction is the front-rear direction, and a case 48 that accommodates the turbo fan. The case 48 is, for example, structured from an injection-molded resin, and is formed in a quadrangular shape as seen from the front-rear direction, and is formed so as to be thin in the front-rear direction.

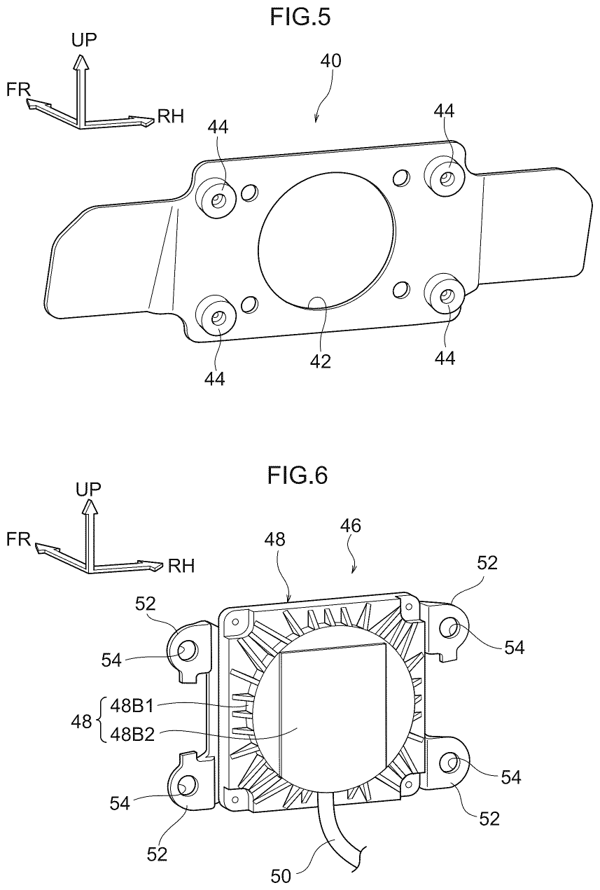

As illustrated in FIG. 4 and FIG. 5, a through-hole 42 that is circular is formed in the left-right direction central portion of the mounting bracket 40. An intake port 48A provided at the case 48 of the blower 46 is inserted in the through-hole 42. The intake port 48A is formed in the shape of a cylindrical tube whose axial direction is the front-rear direction, and is disposed so as to contact the back surface of the seatback pad 24. Although not illustrated, plural intake holes are formed in the seatback pad 24 at places facing the intake port 48A.

As illustrated in FIG. 6, a fan accommodating portion 48B, which is shaped as a cylindrical tube having a bottom and which has a cylindrical-tube-shaped peripheral wall portion 48B1 whose axial direction is the front-rear direction and a bottom wall portion 48B2, is provided at the rear portion of the case 48. The turbo fan is accommodated at the inner side of the peripheral wall portion 48B1, and the turbo fan is covered from the rear side by the bottom wall portion 48B2. Plural, unillustrated exhaust ports are formed in the peripheral wall portion 48B1.

An unillustrated motor that rotates the turbo fan is provided within the case 48. When the turbo fan is rotated by this motor, air at the front surface side (i.e., the occupant side) of the seatback 14 is drawn-in through the aforementioned plural intake holes into the intake port 48A, and is exhausted from the aforementioned plural exhaust ports. Note that 50 in FIG. 2 through FIG. 4 and in FIG. 6 is a harness for supplying electric power to the aforementioned motor.

Two fastening pieces 52, one at the upper side and one at the lower side, are provided at each of the left end portion and the right end portion of the case 48. The respective fastening pieces 52 are formed in the shapes of plates whose thickness direction is the front-rear direction. Screw holes 54 that are circular are formed in the central portions of the respective fastening pieces 52. Four fastening seats 44 are formed at the mounting bracket 40 so as to correspond to the four fastening pieces 52. The respective fastening seats 44 are formed substantially in the shapes of tubes whose axial directions are the front-rear direction.

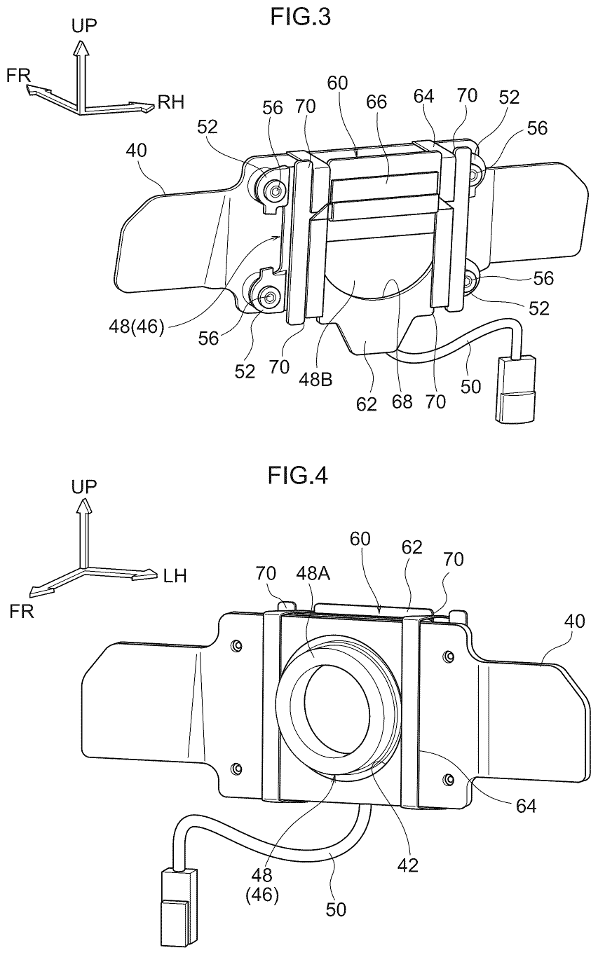

Unillustrated nuts are embedded within the respective fastening seats 44 by insert molding for example. The respective fastening pieces 52 are superposed on the respective fastening seats 44 from the rear side, and screws 56 (see FIG. 3) that are inserted into the respective screw holes 54 are screwed-together with the nuts of the respective fastening seats 44. The blower 46 is thereby mounted to the rear surface of the mounting bracket 40.

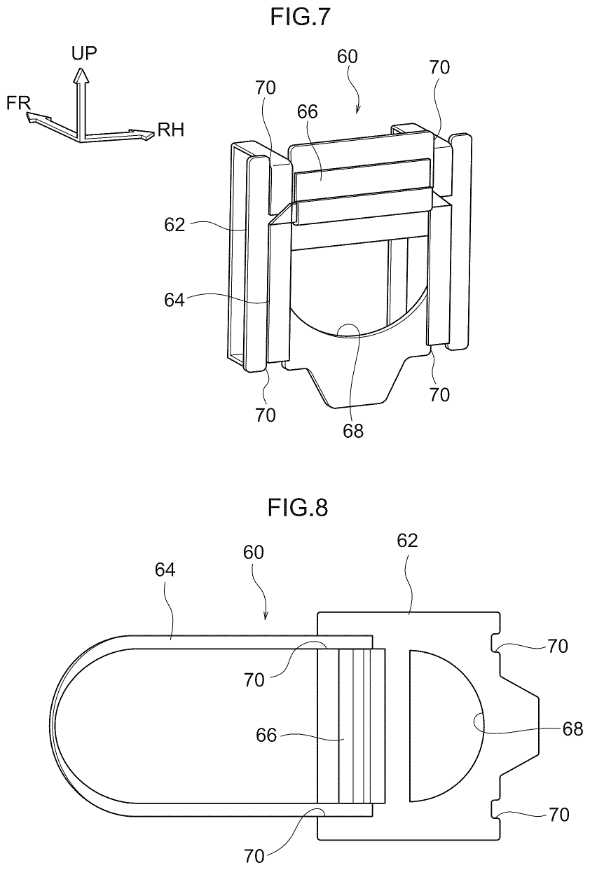

The blower 46 is urged toward the mounting bracket 40 side by an urging portion 60 that is illustrated in FIG. 2 through FIG. 4 and in FIG. 7 and FIG. 8. The urging portion 60 is structured by a rubber band 64 that is an elongated extending/contracting portion, a resin plate 62 that is a sheet-shaped portion, and a J-hook 66 that is a fastener. Together with the left and right lumbar wires 36 and the mounting bracket 40 and the blower 46, this urging portion 60 structures the “blower protection structure of a seatback” relating to the present disclosure.

The rubber band 64 is formed in the shape of an elongated belt, and can extend and contract elastically. The resin plate 62 is structured by a plate material made of resin, and is formed in the shape of a plate (the shape of a sheet) that is substantially rectangular. The resin plate 62 is disposed at the rear side of the blower 46 in a posture such that the front-rear direction is the plate thickness direction of the resin plate 62. A positioning hole 68 that is semicircular is formed in the lower portion of the resin plate 62. The lower portion of the fan accommodating portion 48B of the case 48 is fit into this positioning hole 68. The upper portion of the resin plate 62 contacts the upper portion of the fan accommodating portion 48B from the rear side.

The length direction both end portions of the rubber band 64 are fixed by means such as sewing to the left-right direction both end portions of the upper portion of the resin plate 62. The J-hook 66 is mounted to the left-right direction intermediate portion of the upper portion of the resin plate 62. The J-hook 66 is, for example, manufactured by extrusion molding of a resin, and is fixed to the resin plate 62 by means such as sewing. The J-hook 66 is formed in the shape of the letter J as seen from the left-right direction.

The rubber band 64 is wound on the blower 46 and the mounting bracket 40 from the front side, and the length direction central portion of the rubber band 64 is hooked on the J-hook 66. The rubber band 64 is thereby wound on the blower 46, the mounting bracket 40 and the resin plate 62. By the rubber band 64, the resin plate 62 is pushed from the rear side so as to hit the blower 46, and the blower 46 is urged toward the mounting bracket 40 side (i.e., the front side).

Cut-out portions 70 that respectively are substantially rectangular are formed in the left-right direction both end portions of the upper edge portion and the lower edge portion of the resin plate 62. These cut-out portions 70 correspond to the “positioning portions” in the present disclosure. Length direction intermediate portions of the rubber band 64 are engaged with (here, fit into) the cut-out portions 70. Due thereto, the length direction intermediate portion of the rubber band 64 is positioned at the resin plate 62, and positional offset of the rubber band 64 with respect to the resin plate 62 is prevented.

In the vehicle seat 10 of the above-described structure, the back of the occupant seated on the seat cushion 12 is supported by the seatback 14. In the blower protection structure of a seatback that this seatback 14 has, the mounting bracket 40 is indirectly mounted to the pair of left and right lumbar wires 36 that span between the upper portion and the lower portion of the seatback frame 22. The blower 46 is mounted to the rear surface of the mounting bracket 40. The blower 46 is urged toward the mounting bracket 40 side by the urging portion 60.

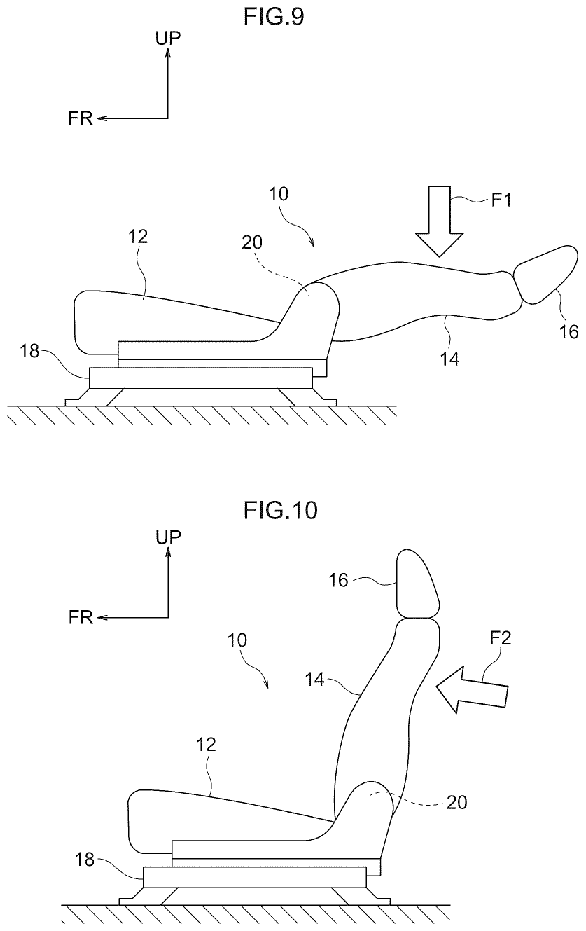

Therefore, for example, as illustrated in FIG. 9, even in a case in which the mounted-together portions (i.e., the fastening pieces 52 and the fastening seats 44) of the blower 46 and the mounting bracket 40 are broken due to an occupant kneeling on the reclined seatback 14 and the weight of the occupant (refer to arrow F1 in FIG. 9) being applied directly onto the blower 46, the blower 46 can be held at the mounting bracket 40 by the urging portion 60.

Due thereto, the blower 46 coming apart from the mounting bracket 40 can be prevented or suppressed, and a gap forming between the blower 46 and the mounting bracket 40 can be prevented or suppressed. Therefore, the blower 46 drawing-in secondary air from the aforementioned gap can be prevented or suppressed. Thus, a failsafe function in a case in which the aforementioned mounted-together portions are broken can be ensured. As a result, the comfort of (the cooling sensation for) the occupant can be ensured, and an increase in noise of the blower 46 can be suppressed.

Note that it can also be thought to, for example, increase the rigidity of the mounting bracket 40 instead of providing the above-described urging portion 60. However, if the rigidity of the mounting bracket 40 is increased, there is the concern that the performance of protecting the occupant from injury (the performance with respect to anti-whiplash in particular), which can be considered to be a basic performance of a vehicle seat, will deteriorate. With regard to this point, in the present embodiment, a certain extent of breakage of the mounted-together portions of the blower 46 and the mounting bracket 40 can be permitted, and therefore, both comfort of the occupant and the noise suppressing performance, and the performance of protecting the occupant from injury, can be achieved.

Further, in the present embodiment, the urging portion 60 has the rubber band 64 that is elongated and can extend and contract, and the urging portion 60 is wound on the mounting bracket 40 and the blower 46. Because the urging portion 60 is wound on the mounting bracket 40 and the blower 46 in this way, it is easy to mount the urging portion 60 to the mounting bracket 40 and the blower 46.

Moreover, the urging portion 60 is formed in the shape of a sheet whose thickness direction is the front-rear direction of the seatback 14, and is disposed at the rear side of the blower 46, and has the resin plate 62 to which the rubber band 64 is fixed. Therefore, even in a case in which an occupant in an unillustrated rear seat kicks the back surface of the seatback 14, and an impact load (refer to arrow F2 in FIG. 10) is applied to the back surface of the seatback 14 from the rear side thereof, the blower 46 can be protected from the rear side by the resin plate 62.

Further, even if the mounted-together portions of the blower 46 and the mounting bracket 40 are broken by the aforementioned impact load F2, a gap forming between the blower 46 and the mounting bracket 40 can be prevented or suppressed. Therefore, the blower drawing-in secondary air from the aforementioned gap can be prevented or suppressed.

Further, at the urging portion 60, the rubber band 64 is wound on the resin plate 62, and length direction intermediate portions of the rubber band 64 are fit into the cut-out portions 70 that are formed in the resin plate 62. The rubber band 64 is thereby positioned with respect to the resin plate 62. Therefore, for example, the intake port 48A of the blower 46 can be prevented from becoming blocked by the rubber band 64 whose position with respect to the resin plate 62 has become offset.

Moreover, the positioning hole 68, into which a portion of the fan accommodating portion 48B of the blower 46 is fit, is formed in the resin plate 62. Due thereto, positional offset of the resin plate 62 with respect to the blower 46 can be prevented. As a result, for example, the exhaust ports of the blower 46 can be prevented from becoming blocked by the resin plate 62 whose position with respect to the blower 46 has become offset.

Note that the above-described first embodiment is structured such that the positioning hole 68 and the cut-out portions 70 (positioning portions) are formed in the resin plate 62 (the sheet-shaped portion). However, the present disclosure is not limited to this, and may be structured such that the positioning hole 68 and the cut-out portions 70 are not formed in the resin plate 62. Further, positional offset of the resin plate 62 and the rubber band 64 may be prevented by, for example, causing engaging portions such as notches or the like that are formed in the resin plate 62 to engage with the blower 46 or the rubber band 64.

### Second Embodiment

A second embodiment of the present disclosure is described next. Note that structures and operations that are basically similarly to those of the first embodiment are denoted by the same reference numerals as in the first embodiment, and description thereof is omitted.

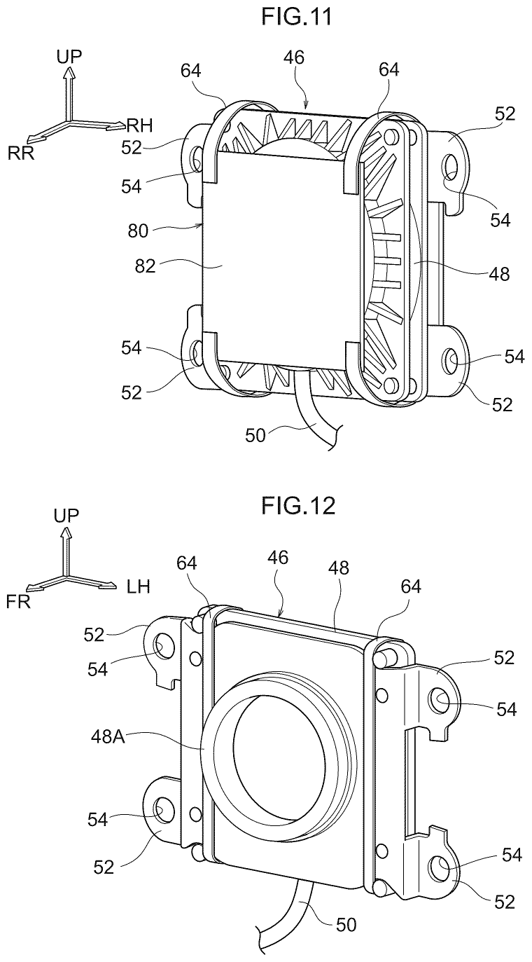

The blower 46 for a vehicle seat and an urging portion 80 relating to the second embodiment are illustrated in perspective views in FIG. 11 and FIG. 12. Note that illustration of the mounting bracket 40 is omitted in FIG. 11 and FIG. 12. In this embodiment, the urging portion 80 is structured by a fabric-like portion 82 structured from a fabric-like material (e.g., felt), and a pair of left and right rubber bands 64 that are fixed to the fabric-like portion 82. The fabric-like portion 82 corresponds to the “sheet-shaped portion” in the present disclosure. Note that the material of the fabric-like portion 82 is not limited to a fabric, and it suffices for it to be a sheet-shaped or a plate-shaped material that is flexible and impact-absorbent such as a thick fabric, and may be rubber or a foamed body.

The fabric-like portion 82 is formed in a rectangular shape as seen from the front-rear direction, and in the shape of a sheet whose thickness direction is the front-rear direction. The fabric-like portion 82 is disposed at the rear side of the blower 46. At the left and right rubber bands 64, respective length direction one end portions thereof are fixed (sewn) to the left and right both end portions of the upper end portion of the fabric-like portion 82, and the respective length direction other end portions thereof are fixed (sewn) to the left and right both end portions of the lower end portion of the fabric-like portion 82. The left and right rubber bands 64 are wound on the blower 46 and the mounting bracket 40, and the blower 46 is urged toward the mounting bracket 40 side by the urging portion 80. In this embodiment, structures other than those described above are similar to the first embodiment.

In this embodiment as well, the blower 46 can be held at the mounting bracket by the urging portion 80. Therefore, in the same way as in the first embodiment, the blower 46 drawing secondary air in from a gap between the blower 46 and the mounting bracket 40 can be prevented or suppressed. Further, in this embodiment, because the fabric-like portion 82 that is formed from a fabric-like material is disposed at the rear side of the blower 46, the blower 46 can be effectively protected from impact load (refer to arrow F2 in FIG. 10) that is applied to the back surface of the seatback 14.

Note that, in the above-described respective embodiments, the urging portion 60, 80 is structured to have the resin plate 62, the fabric-like portion 82 that is the sheet-shaped portion, but the present disclosure is not limited to this, and the urging portion 60, 80 may be a structure formed only from the rubber band(s) 64.

Further, in the above-described respective embodiments, the blower 46 is structured so as to be mounted (fastened and fixed) to the mounting bracket 40, but the present disclosure is not limited to this and may be structured such that the blower 46 is held at the mounting bracket 40 only by the urging force of the urging portion and without being mounted to the mounting bracket 40. In this case, it is preferable to prevent positional offset of the blower 46 with respect to the mounting bracket 40 by, for example, forming a guide-shaped portion or the like provided at the mounting bracket 40 or the blower 46.

In addition, the present disclosure can be implemented by being modified in various ways within a scope that does not depart from the gist thereof. Further, the scope of the right of the present disclosure is, of course, not limited by the above-described, respective embodiments.

What is claimed is:

1. A blower protection structure of a seatback, comprising:
a pair of left and right lumbar wires spanning between an upper portion and a lower portion of a seatback frame of a vehicle seat;
a mounting bracket mounted directly or indirectly to the left and right lumbar wires;
a blower disposed at a seatback rear side with respect to the mounting bracket; and
an urging portion urging the blower toward a mounting bracket side.

2. The blower protection structure of a seatback of claim 1, wherein the blower is mounted to a seatback rear side surface of the mounting bracket.

3. The blower protection structure of a seatback of claim 1, wherein the urging portion has an elongated extending/contracting portion that is configured to extend and contract, and the urging portion is wound on the mounting bracket and the blower.

4. The blower protection structure of a seatback of claim 3, wherein the urging portion has a sheet-shaped portion that is formed in a shape of a sheet whose thickness direction is a front-rear direction of the seatback, that is disposed at the seatback rear side with respect to the blower, and to which the extending/contracting portion is fixed.

5. The blower protection structure of a seatback of claim 4, wherein:
the extending/contracting portion is wound on the sheet-shaped portion, and
the sheet-shaped portion has a positioning portion that positions the extending/contracting portion at the sheet-shaped portion by engaging with a length direction intermediate portion of the extending/contracting portion.

6. The blower protection structure of a seatback of claim 4, wherein a positioning hole into which a portion of the blower is fit is formed in the sheet-shaped portion.

7. The blower protection structure of a seatback of claim 4, wherein the sheet-shaped portion comprises a fabric-like material.

8. A vehicle seat, comprising:
a seat cushion on which an occupant sits; and
a seatback supporting a back of the occupant,
wherein the seatback has the blower protection structure of a seatback of claim 1.
